(19) United States
(12) Patent Application Publication
(10) Pub. No.: US 2020/0154810 A1
(43) Pub. Date: May 21, 2020

(54) PACIFIER SECURING DEVICE AND SYSTEM WITH ARTICULATABLE COMPONENTS

(71) Applicant: Brandon Prescott, Riverton, UT (US)

(72) Inventor: Brandon Prescott, Riverton, UT (US)

(21) Appl. No.: 16/191,731

(22) Filed: Nov. 15, 2018

(51) Int. Cl. A42B 1/24; A45F 5/02

(52) U.S. Cl. CPC A42B 1/24; A61J 17/001; A45F 5/02

(57) ABSTRACT

Devices, systems, and apparatus for retaining a pacifier for use by a child. In an embodiment of the device, the device may include a pacifier guide retainer and a pacifier guide member. The pacifier guide retainer may include an opening. The pacifier guide member may include an elongated guide member and may be disposed within the opening of the pacifier guide retainer. The elongated guide member comprises a length sufficient to retain the pacifier guide member within the opening of the pacifier guide retainer and allow the pacifier guide member to slide back and forth in the opening. Systems including the device as well as methods and processes for the construction and use of such systems and devices are also included.

### BACKGROUND

Various attempts to retain a pacifier for use by a baby without it being dropped are known in the art. Typically, a strap attached to pacifier is secured to a child's clothing with a clip or fastener. These retainers are typically unsuitable for use with newborns who lack the dexterity to replace a dropped pacifier by hand. Other systems which use straps secured to a baby's ears or a hat are known which retain a pacifier in a newborns mouth. By using textile straps to retain the pacifier, such systems require laundering for adequate cleaning. Additionally, many such systems lack the ability for the baby to remove and replace the pacifier from its mouth for use as may be desired.

Other attempted solutions have resulted in systems that simply hold a pacifier in a child's mouth so it cannot be removed. However, this can effectively act as a gag and should a baby vomit or “spit up” can run the risks of aspiration or gagging.

A system or method for retaining a pacifier in position for use by newborn, which allows for a baby to remove the pacifier and then replace it as desired by simply suckling would be an improvement in the art. Such a system or device that is easy to thoroughly clean while in use would be a further improvement in the art.

### SUMMARY

The present disclosure extends to systems and apparatus for retaining a pacifier for use by a child. In one illustrative embodiment, a guide retaining portion formed as a pacifier guide retainer extends from at least one attachment on a headwear item to a central portion which includes a guide opening formed as a hole disposed therethrough. A pacifier guide member includes an attachment portion for attachment to a pacifier at a proximal end and a guide member extending from the attachment portion to a distal end. The guide member may taper from the distal end towards the attachment portion, such that when the guide member is placed in the guide opening, it partially extends and retracts through the guide opening and is abuttably prevented from being removed therefrom.

The retaining system may be articulated to allow for adjustment for individuals as needed. The use of relatively rigid and/or nonporous materials for the different components may allow for easy cleaning while in use.

Methods and processes for constructing and using such systems and apparatus are also included within the present disclosure.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates a perspective and front view of a first embodiment of a pacifier retainer system in accordance with the technologies and features of the disclosure;

FIGS. 2A and 2B are front views of a pacifier guide member and a pacifier guide retainer, respectively;

FIG. 3 is a side view of an alternative embodiment of a pacifier retainer system in accordance with the technologies and features of the disclosure;

FIG. 4 is a side view of an alternative embodiment of a pacifier retainer system in accordance with the technologies and features of the disclosure; and

FIG. 5 is a perspective front view of another embodiment of a pacifier retainer system in accordance with the technologies and features of the disclosure.

### DETAILED DESCRIPTION

The present disclosure extends to apparatuses, methods, and systems for retaining a pacifier for use by an infant. More specifically, the disclosure extends to pacifier retainer systems that feature components made from relatively rigid materials, which allow for movement of the pacifier in a defined area to allow a child to remove and restore the pacifier from the mouth for use by using the lips, as well as methods and processes associated with the use and production of such systems and apparatus. The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the structure, systems and methods for retaining pacifiers are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

In the flowing description of the disclosure, certain terminology is used for the purpose of reference only and is not intended to be limiting. Terms such as “upper,” “lower,” “above,” and “below,” refer to directions in the drawings to which reference is made. Terms such as “inward” and “outward” refer to directions towards and away from, respectively, the geometric center of the component described. Terms such as “side,” “top,” “bottom,” “horizontal,” “with in,” “inside,” and “vertical,” describe the orientation of portions of the component within a consistent but arbitrary frame of reference which is made clear by reference to the text and the associated drawings describing the component under discussion. Such terminology includes words specifically mentioned above, derivatives thereof, and words of similar import.

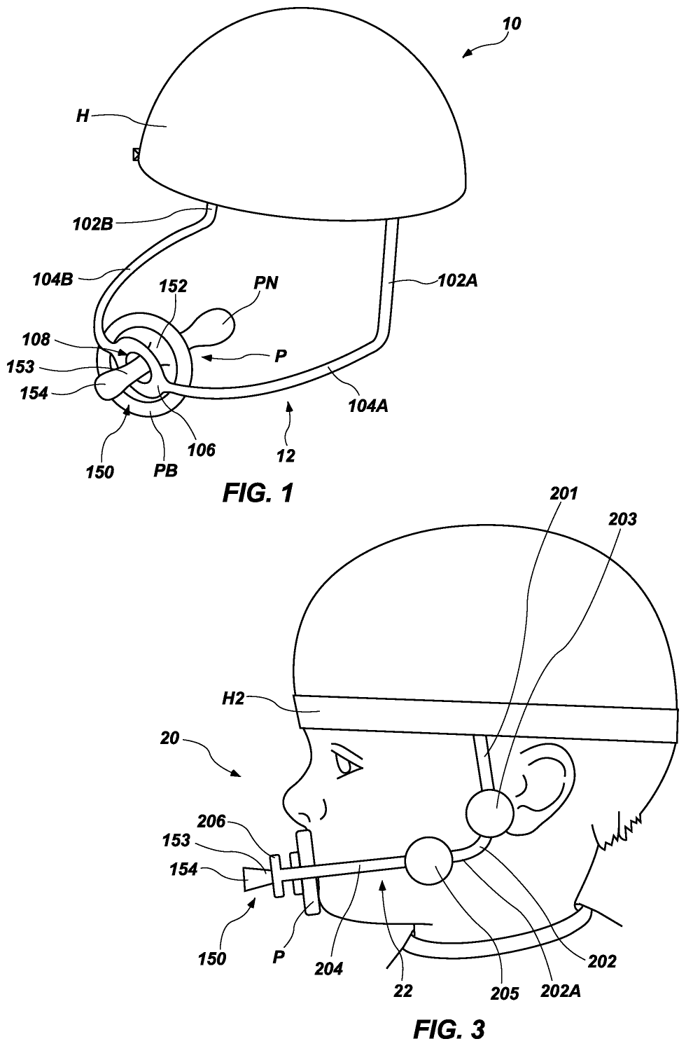

Referring now to the figures, FIG. 1 depicts a first illustrative embodiment of a device and system 10 for retaining a pacifier P for use by a child, such as an infant, in accordance with the principles and technologies of the present disclosure. As depicted, pacifier P may be an injection molded pacifier of one-piece construction that is intended for use by a child, such as an infant or newborn. Such a pacifier P may have a relatively wide or elongated base PB having a front surface PB2 and a rear surface PB4 with an elongated nipple PN extending from the front surface PB2 of the base PB. It will be appreciated that the elongated base PB is considered relative wide with respect to the remaining components of the system 10, for example, in the depicted embodiment, base PB has an outside diameter or length that is greater than a diameter or length across aperture 108.

It will be further appreciated that the depicted pacifier P is merely illustrative and that systems and devices in accordance with the present disclosure may be designed for use with different pacifiers that are commercially available from different manufacturers, or that may be recommended for use by different children for medical or other reasons. For example, a pacifier with a flexible nipple attached to a rigid plastic base could be used.

The system 10 may be attached to a headpiece or headwear H. It will be appreciated that the headpiece H may be any suitable headpiece or headwear that is worn by a child, including but not limited to a headband, a hat, a helmet used for medical purposes, or a hat that may be shaped as a helmet (such as a football or baseball helmet), or any other headpiece designed to be worn by a child.

A pacifier guide retainer 12, which may be a face bar, may comprise an opening 108 with a first diameter. The pacifier guide retainer 12 may be formed as a retaining member that is relatively rigid in nature. In the depicted embodiment pacifier guide retainer 12 is defined as a curved pacifier guide retainer. It will be appreciated that the term “relatively rigid” with respect to the components of system 10 means construction from materials that are generally rigid in nature, such as plastic or other polymeric materials that are resistant to bending, while recognizing that such materials also possess at least a slight degree of flexibility, as opposed to materials that are inherently flexible such as ribbons and fabric textile materials used in known pacifier retaining systems.

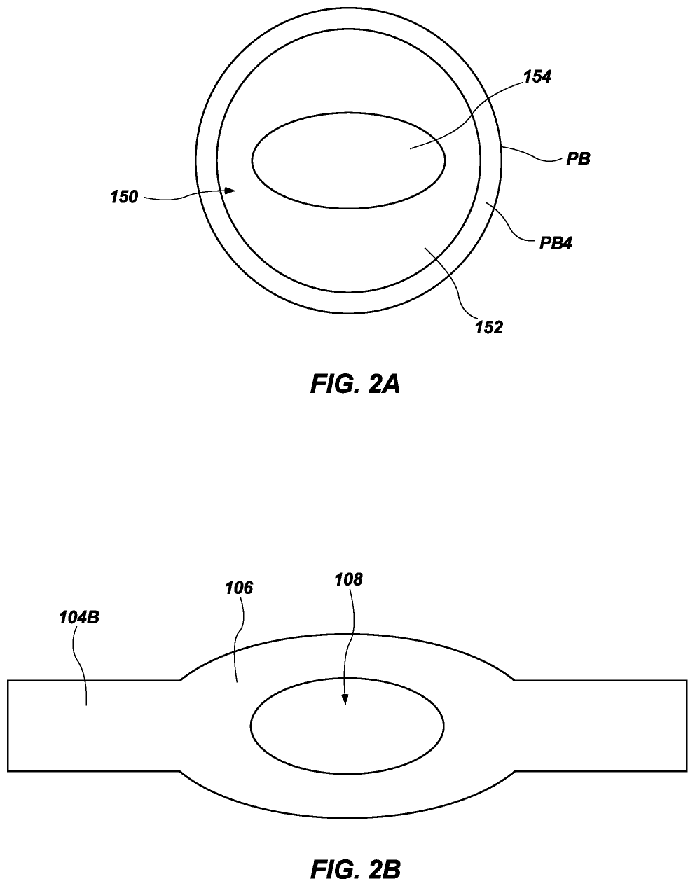

As depicted, the pacifier guide retainer 12 may have a plurality of counterpart upper or first bars 102A and 102B. First bars 102A and 102B may be attached to the headpiece H at their proximal ends, and may extend from attachments to the headpiece H, substantially following the jaw line of a child as illustrated in FIG. 2. It will be appreciated that in alternate embodiments, only a single first bar 102, attached one side of the headpiece H. Further, it will be appreciated that although referred to as bars, the first bars 102 may have a rounded, or curved, cross-sectional shape such that sharp corners are not present or exposed near a child.

In the depicted embodiment, the first bars 102A and 102B may extend downwardly from the headpiece H. A plurality of counterpart lower or second bars 104A and 104B may extend from a distal end of the first portions 102A and 102B and extend towards one another to join a central guide portion 106. Pacifier guide retainer 12, and the portions thereof (bars 102, 104, and 106) may be curved such that they follow the curve of a child's jaw line or face while being spaced apart therefrom. The central guide portion 106 may include a pacifier guide opening 108 therethrough. It will be appreciated that in embodiments with only a single first bar 102, only a single second bar 104 may be present, and that second bar 104 and central guide portion 106 may have rounded, or curved, cross-sectional shapes such that sharp corners are not present or exposed near a child.

Central guide portion 106 and pacifier guide member 150 are depicted in more detail in FIGS. 2A and 2B, and the interactions therebetween may be more readily understood by reference to these figures.

The pacifier guide member 150 may comprise a pacifier stop or guide member end 154 that is disposed or located within the opening 108 of the pacifier guide retainer 12. The pacifier stop 154 may taper from a second diameter that corresponds with the first diameter of the opening 108. The second diameter of the pacifier stop 154 may be the same diameter as the first diameter of the opening 108 or may be larger than the first diameter of the opening 108. The pacifier stop 154 may taper from the second diameter to a third diameter that is less than the first diameter of the opening 108. The pacifier guide member 150 may be retained within the opening 108 when the pacifier stop 154 is rotated such that the second diameter of the pacifier stop 154 contacts the first diameter of the opening 108. The pacifier stop 154 may be positioned within the opening 108 such that it slides back and forth in the opening 108. The opening 108 may be an ovoid and the first diameter corresponds to a length of the ovoid opening 108. The pacifier retainer 12 may comprise a horizontal connector 104 attached to a vertical connector 102 and the vertical connector 102 connects to the headpiece H. It will be appreciated that at least one of the horizontal connector 104 and the vertical connector 102 includes an articulation member to allow 205 or 203 as illustrated and explained below in more detail in relation to FIG. 3.

The pacifier guide member 150 may be formed as a separate body. The pacifier guide member 150 may include an attachment portion 152 for attachment to a pacifier P at a proximal end of the pacifier guide member 150. In the depicted embodiment in FIG. 1, the attachment portion 152 may include an enlarged disc 155 that is secured to the pacifier P. As depicted, the pacifier guide member 150 may be secured to the rear surface PB4 of the pacifier base PB, such that only the pacifier P and nipple PN are accessible to the child. This may be accomplished in any suitable manner, for example by using a suitable adhesive disposed between the disc and the pacifier base PB or by suitable fasteners extending into the structures that comprise the pacifier guide member 150 and the pacifier base PB.

It will be appreciated that for embodiments which are attached to a different type of pacifier P, that the attachment to the pacifier guide member 150 may be made in a suitable fashion. For example, where a pacifier having a rigid plastic base is used, the pacifier guide member 150 may be fastened to the rigid plastic base without the use of an enlarged portion.

Pacifier guide member 150 may further include an elongated guide member 153 and the pacifier stop or guide member end 154, which may also be a “tail,” extending rearward from the attachment portion 152. The elongated guide member 153 may comprise a length sufficient to retain the pacifier guide member 150 within the opening 108 of the pacifier guide retainer 12 and allow the pacifier guide member 150 to slide back and forth in the opening 108. The elongated guide member 153 may be of a sufficient length to be used alone or it may be used in conjunction with the pacifier stop 154.

The pacifier stop or guide member end 154 may have an ovoid, irregular, or oblong cross-sectional shape to the stop portion, that tapers to the elongated guide member, which may be a narrower portion adjacent the attachment portion 152, to a thicker, stop portion of the end 154. The pacifier guide opening 108 in the central guide portion 106 may be formed to have a corresponding shape, and, to closely correspond to the thicker portion of the pacifier stop 154, such that the allow the pacifier stop 154 may be inserted therethrough when aligned in a specific position, as shown in FIGS. 2A and 2B.

After insertion, the guide member 150 may be rotated out of the specific position, such that the guide member 150 may be abuttably retained in the central guide portion 106 in a defined restricted, but moveable manner. Specifically, when the pacifier stop 154 is placed in the pacifier guide opening 108, it is able to partially extend and retract through the pacifier guide opening 108, but is abuttably prevented from being removed therefrom. More specifically, unless rotated to the specific removal alignment, the pacifier stop 154 may move freely in the guide opening 108, but cannot be removed therefrom.

Thus, the guide member 150 may move slidably towards and away from the central guide portion 106, and may even move laterally within the guide opening 108 as the guide member end 154 or “tail” slides through the pacifier guide opening 108, restricted as the guide member end 154 abuts the central guide portion 106. This allows the pacifier P and nipple PN to move in a corresponding manner. The guide member end 154 and pacifier guide opening 108 may be sized and positioned to allow a pacifier P to be in the child's mouth or to retract therefrom with the tip of the nipple PN on or near the child's lips. This allows the child to suck the pacifier P into the mouth when desired, and to push it away when it is not wanted. This also allows the child to spit-up or otherwise eject material from the mouth without contact or other obstruction from the pacifier P.

It will be appreciated that in other embodiments, the pacifier guide member 150 may be retained in the pacifier guide opening 108 using other abutting mechanisms and other mechanical relationships that allow for such abutting movement. For example, rather than using abuttable retention by rotation of the guide member end 154, in alternative embodiments, the guide member end 154 could be formed with a distal end that is too large to pass through the pacifier guide opening 108 tapering towards the connection portion 152. The guide member end 154 may be a separate piece that is threadably attached to the connection portion 152, as by having a hollow bore or hole into which a shaft on the connection portion threads (or vice versa).

In another embodiment, the guide member end 154 may not be tapered, in order to ease insertion and replacement, and rely solely on the length of “tail” to prevent removal, but that such an embodiment may lack other advantages of the depicted systems.

Pacifier guide retainer 12 and pacifier guide member 150 may be constructed from relatively rigid materials to retain their positions away from the child's face. Preferably, these materials may be relatively nonporous to allow for easy cleaning as by wiping with a standard baby wipe. It will be appreciated that the use of solid injected molded components may allow each component to be of a sufficient size that, in the event the system comes undone, the components do not present a choking hazard for the child.

Turning to FIG. 3, a second illustrative embodiment of a system 20 for retaining a pacifier P for use by a child or infant in accordance with the principles and technologies of the present disclosure. As with the embodiment of FIG. 1, the pacifier P may be an injection molded pacifier of one-piece construction that is intended for use by a child, such as a newborn, or as otherwise known.

As depicted, system 20 may be attached to a headpiece or headwear, which is illustrated in FIG. 3 as a headband H2, but it will be appreciated that any headpiece or headwear may be utilized. On opposite sides of the headband H2, two corresponding ear loops 201 extend downwards, for placement around the ears of a child wearing the headband H2. It will be appreciated that counterpart structures not depicted in the side view are present on the systems 20. Ear loop 201 may be formed as extension of the headband using a textile or other material suitable for skin contact. In other embodiments, the ear loop 201 may be constructed from the same relatively rigid material as pacifier guide retainer 22.

Relatively rigid pacifier guide retainer 22 may have a plurality of counterpart first portions 202 that attach to the ear loops 201. A plurality of counterpart second portions 204 may extend from a distal end 202A of the first portions 202. In an embodiment, there are two counterpart first portions 202 and two counterpart second portions 204. The plurality of counterpart second portions 204 may extend toward one another to join a central guide portion 206. Pacifier guide retainer 22, and the portions 202, 204, and 206 thereof may be curved such that they follow the jaw line or the curve of a child's face while being spaced apart therefrom with the central guide portion 206 residing near a child's mouth, preferably spaced directly thereover. The central guide portion 206 may include a pacifier guide opening 208 therethrough. As discussed previously herein with respect to FIG. 1, it will be appreciated that alternate embodiment having only a single ear loop 201 first and second portions may be used where desirable.

At the attachment points between first portion 202 and ear loop 201, and between first portion 202 and second portions 204, there may be disposed articulation structures 203 and 205, respectively. These may be formed as hinges, such as injected molded components that snap together or use a central fastener, such as a rivet, as an axle to allow rotation. It will be appreciated that other mechanical articulation structures may be utilized. Such articulation structures may include “stops” formed in the internal structures therein, or, be of sufficient frictional engagement within the internal structures to keep the structures in a desired position when “bumped” by the usual movements of a child or baby. The use of the articulation structures 203 and 205 allows the system 20 to be adjusted to keep the central guide portion 206 and pacifier guide opening 208 aligned with the child's mouth and the pacifier guide retainer 22 spaced from the child's face.

As with system 10, guide member 150 may reside in the guide opening 208 in central guide portion 206 and be movable therein as the shaft of the guide member end 154 is abuttably retained therein in a defined restricted moveable manner.

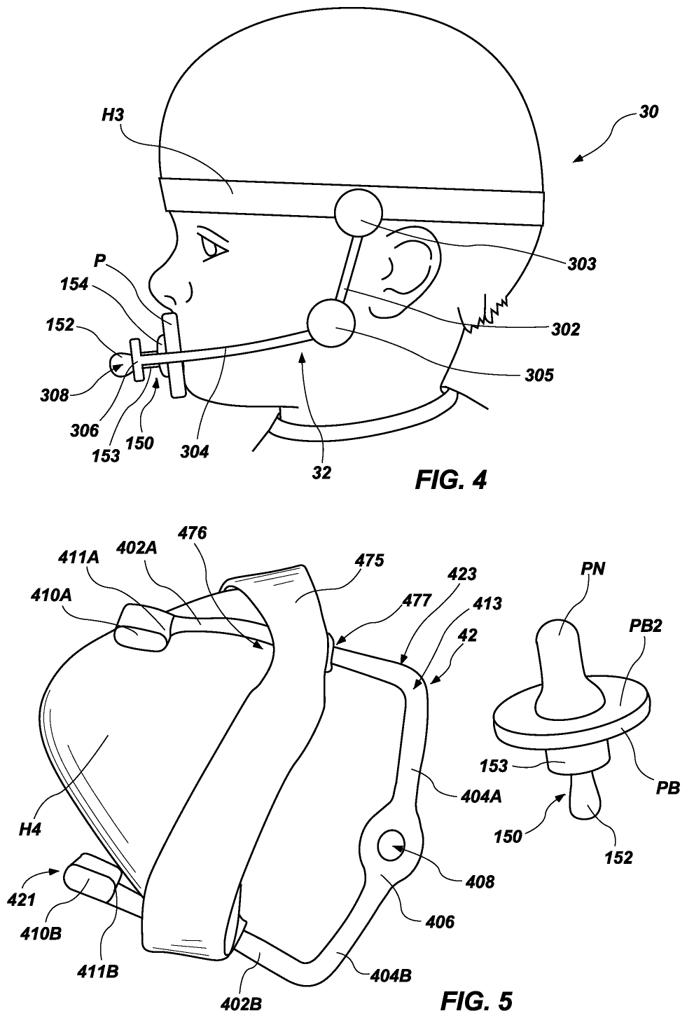

Turning to FIG. 4, a third illustrative embodiment of a system 30 for retaining a pacifier P for use by a child or infant in accordance with the principles and technologies of the present disclosure. As with the embodiments of FIGS. 1 and 3, the pacifier P may be an injection molded pacifier of one-piece construction that is intended for use by a child or a newborn.

As depicted, system 30 may be attached to a headpiece or headwear, which is illustrated in FIG. 4 as a headband H3, but it will be appreciated that any headpiece or headwear may be utilized. On opposite sides of the headband H3, a plurality of counterpart first portions 302 attach to the headband H3 and extend downwards. It will be appreciated that counterpart structures on the opposite side that are not depicted in the side view may be present in the system 30. A plurality of counterpart second portions 304 may extend from a distal end of the first portions 302. In an embodiment, there are two counterpart first portions 302 and two counterpart second portions 304. The plurality of counterpart second portions 304 may extend towards one another to join a central guide portion 306. Pacifier guide retainer 32, and the portions 302, 304, and 306 thereof may be curved such that they follow the jaw line or the curve of a child's face while being spaced apart therefrom with the central guide portion 306 residing near a child's mouth, preferably spaced directly thereover. The central guide portion 306 may include a pacifier guide opening 308 therethrough.

At the attachment points between first portions 302 and headband H3, and between first portions 302 and second portions 304, there may be disposed articulation structures 303 and 305, respectively. These may be formed as hinges, such as injected molded components that snap together or use a central fastener, such as a rivet, as an axle to allow rotation. It will be appreciated that other mechanical articulation structures may be utilized. Such articulation structures may include “stops” formed in the internal structures therein, or, be of sufficient frictional engagement within the internal structures to keep the structures in a desired position when “bumped” by the usual movements of a child or baby. The use of the articulation structures allows the system 30 to be adjusted to keep the central guide portion 306 and pacifier guide opening 308 aligned with the child's mouth and the pacifier guide retainer 32 spaced from the child's face.

As with systems 10 and 20, guide member 150 may reside in the pacifier guide opening 308 in central guide portion 306 and be movable therein as the shaft of the guide member end 154 is abuttably retained therein in a defined restricted moveable manner.

Turning to FIG. 5, a fourth illustrative embodiment of a system 40 for retaining a pacifier P for use by an infant in accordance with the principles and technologies of the present disclosure. As with the embodiments of FIGS. 1, 3 and 4, the pacifier P may be an injection molded pacifier of one-piece construction that is intended for use by a child, such as a newborn. It will be appreciated that in other embodiments, different pacifiers, as known to those of skill in the art, may be used.

As depicted, system 40 may be constructed for attachment to a headpiece or headwear, such as a hat H4. In the depicted embodiment, the hat H4 may be a stocking cap sized for use for a newborn, but it will be appreciated that the hat may be sized for use with the head size of any child. Hat H4 may include a lower band 475, as may be formed by a folded and hemmed edge, that defines one or more pockets 476 around a lower end of the hat H4. At counterpart positions around the sides of the hat H4, openings, such as that indicated at 477 may allow access to the pocket from the rim of the hat H4.

At an upper end 421 of pacifier guide retainer 42, a plurality of counterpart attachment portions 410A and 410B may be formed as relatively larger members that are shaped to conform to the sides of a baby's head and to be retained in the pocket 476 of the hat or cap H4. At a lower end 411A or 411B of each attachment portion 410A or 410B, the attachment portion may have a generally elongated and planar, or rounded, lower edge for retaining in the pocket 476.

A plurality of counterpart first portions 402A and 402B may extend from the lower edge of the counterpart attachment portions 410A and 410B. Upon placement in the pocket 476, the first portions 402A and 402B extend respectively through openings 477A and 477B and extend downwards. At a distal end 423 of each first portions 402A or 402B, a plurality of counterpart second portions 404A and 404B extend towards one another to join a central guide portion 406. In an embodiment, there are two counterpart first portions 402 and two counterpart second portions 404. Pacifier guide retainer 42, and the portions 402, 404, and 406 thereof may be curved such that they follow the jaw line or the curve of a child's face while being spaced apart therefrom. The central guide portion 406 may include a pacifier guide opening 408 therethrough.

At the junction 413 between first portion a 402 and an attachment portion 410, and between first portion 402 and second portions 404, there may be disposed an articulation structure (not shown) which may be similar in implementation and description to articulation structures 203 and 205 in FIG. 2 and articulation structures 303 and 305 shown in FIG. 3.

As with systems 10, 20, and 30, guide member 150 may reside in the pacifier guide opening 408 in central guide portion 406 and be movable therein as the shaft of the guide member end 154 is abuttably retained therein in a defined restricted moveable manner. In one illustrative embodiment, this may be accomplished by having the pacifier guide opening 408 and the central guide portion 406 formed to have a corresponding shape, and be sized to closely correspond to the thicker portion of the guide member end 154, as depicted in FIGS. 2A and 2B, such that the allow the guide member end 154 may be inserted therethrough when aligned in a specific position and, after insertion, the guide member 150 may be rotated out of the specific position, such that the guide member 150 may be abuttably retained in the central guide portion 406 in a defined restricted moveable manner.

The present disclosure further includes methods of constructing and using systems and apparatus in accordance with the present disclosure. In one such illustrative method, for securely providing a pacifier to a newborn, a user may attach a pacifier to a rigid pacifier guide member, as discussed previously herein. The rigid pacifier guide member may include a guide member extending from the attachment point to a distal end, where the guide member tapers from the distal end towards the attachment portion. The rigid pacifier guide member and guide member may be constructed along the lines discussed previously herein. The attachment may be made by using a suitable adhesive, by using fasteners to secure the pacifier to the guide, or as otherwise known.

The guide member of the pacifier guide member may be inserted into a guide opening formed as a hole or a bore in a central guide portion of a rigid curved pacifier guide retainer, such that when the guide member is able to partially extend and retract through the guide opening but is abuttably prevented from being removed therefrom, as discussed previously herein. For example, where the guide member has a non-circular cross-sectional shape it may be inserted into a guide opening having a corresponding shape, such that the distal end of the guide member may be inserted through bore of the guide opening when aligned in a specific alignment. The pacifier guide member may then be rotated to thereby rotate the guide member such that it is abuttably prevented from being removed from the guide opening. In other embodiments, it may be inserted in a suitable manner for such embodiment.

It will be appreciated that this insertion for attachment of the pacifier guide member to the curved pacifier guide retainer may be performed before or after the pacifier is attached to the pacifier guide member, depending on the particular components being used and the conditions where the method is being performed.

The user may position the rigid curved pacifier guide retainer in a secured position in connection with a headwear item on a newborn's head, such that the guide opening is disposed to align with the mouth of the newborn. The newborn may then use or push out the pacifier as desired, using the movement allowed by the guide member and pacifier guide retainer.

In one illustrative embodiment, the positioning may be performed by placing a headwear item, such as a cap or hat, to which the rigid curved pacifier guide retainer is attached on the newborn's head. In others, it may be performed by attaching the pacifier guide retainer to a headwear item already worn by the newborn. Positioning may further include adjusting a rigid pacifier guide retainer including articulation pointes to achieve the best positioning of the pacifier guide retainer and pacifier with respect to the newborn's face and mouth.

### Examples

The following examples pertain to further embodiments.

Example 1 is a device for retaining a pacifier. The device includes a pacifier guide retainer having an opening and a pacifier guide member that is disposable within the opening of the pacifier guide retainer. The pacifier guide member includes an elongated guide member comprising a length sufficient to retain the pacifier guide member within the opening of the pacifier guide retainer and allow the pacifier guide member to slide back and forth in the opening.

In Example 2, the device of Example 1, wherein the opening of the pacifier guide retainer comprises a first diameter. The pacifier guide member comprises a pacifier stop wherein the pacifier stop tapers from a second diameter that is the same diameter as the first diameter or is larger than the first diameter to a third diameter that is less than the first diameter.

In Example 3, the pacifier guide member as in any of Examples 1-2, wherein the pacifier guide member is retained within the opening when the pacifier stop is rotated such that the second diameter of the pacifier stop contacts the first diameter of the opening.

In Example 4, the device of any of Examples 1-3, wherein the pacifier stop slides back and forth in the opening.

In Example 5, the device of any of Examples 1-4, wherein the opening is an ovoid and the first diameter corresponds to a length of the ovoid opening.

In Example 6, the device of any of Examples 1-5, wherein the pacifier retainer includes a horizontal connector attached to a vertical connector and the vertical connector connects to a headpiece.

In Example 7, the device of any of Examples 1-6, wherein at least one of the horizontal and vertical connector includes an articulation member.

Example 8 is a system for retaining a pacifier. The system includes a pacifier guide retainer extending from at least one attachment on a headwear item to a central portion, wherein the central portion includes a guide opening defined by a surrounding sidewall forming a hole therethrough. The system further includes a pacifier guide member that has an attachment portion for attachment to a pacifier at a proximal end of the pacifier guide member. The pacifier guide member further includes an elongated guide member extending outwardly with respect to the attachment portion to a distal end of the pacifier guide member. The elongated guide member tapers from the distal end towards the attachment portion, such that when the elongated guide member is placed in the guide opening, it partially extends and retracts through the guide opening thereby retaining the pacifier in a position for use by a child.

In Example 9, the system of Example 8, wherein the pacifier guide retainer and the pacifier guide member are constructed of a rigid material.

In Example 10, the system of any of Examples 8-9, wherein the pacifier guide retainer extending from at least one attachment on a headwear item to a central portion comprises the pacifier guide retainer extending from two corresponding attachments on either side of the headwear item to the central portion.

In Example 11, the system of any of Examples 8-10, wherein the pacifier guide retainer comprises at least one downwardly extending portion connected to at least one corresponding horizontal portion, and further comprising at least one articulation joint disposed between the at least one downwardly extending portion and the at least one horizontal portion to allow adjustment therebetween.

In Example 12, the system of any of Examples 8-11, wherein the guide member has a non-circular cross-sectional shape and the hole of the guide opening of the pacifier guide retainer has a corresponding shape, such that the distal end of the guide member may be inserted through the hole of the guide opening when aligned in a specific alignment and then rotated such that it is abuttably prevented from being removed therefrom.

In Example 13, the system of any of Examples 8-12, wherein the headwear comprises a hat, a headband, or a helmet.

In Example 14, the system of any of Examples 8-13, wherein the pacifier guide retainer is attached to loops attached to the headwear.

In Example 15, the system of any of Examples 8-14, wherein the two corresponding attachments comprise two enlarged portions at either end of the pacifier guide retainer that are retained in at least one pocket disposed on the headwear.

Example 16 is a pacifier retaining system for a child. The system includes a rigid pacifier guide retainer that extends from two corresponding attachment structures for attachment to a headwear item to a central guide portion. The system further includes a guide opening formed as a hole in the central guide portion, the guide opening defined by a surrounding sidewall. The system further includes a rigid pacifier guide member that includes a first end for attachment to a pacifier and an elongated guide member extending from the first end to a second end, such that when the elongated guide member is placed in the guide opening, it partially extends and retracts through the guide opening.

In Example 17, the system of Example 16, wherein the elongated guide member tapers from the second end towards the first end, such that when the elongated guide member is placed in the guide opening in the central guide member, it partially extends and retracts through the guide opening and is abuttably prevented from being removed therefrom.

In Example 18, the system of any of Examples 16-17, wherein the elongated guide member has a non-circular cross-sectional shape and the hole of the guide opening has a corresponding shape, such that the distal end of the guide member may be inserted through hole of the guide opening when aligned in a specific alignment and then rotated such that it is abuttably prevented from being removed therefrom.

In Example 19, the system of any of Examples 16-18, wherein the two corresponding structures for attachment to a headwear item comprise two enlarged portions at either end of the pacifier guide retainer that are retained in at least one pocket disposed on the headwear.

In Example 20, the system of any of Examples 16-19, wherein the pacifier guide retainer comprises at least one downwardly extending portion connected to at least one corresponding horizontal portion, and further comprising at least one articulation joint disposed between the at least one downwardly extending portion and the at least one horizontal portion to allow adjustment therebetween.

In Example 21, the system of any of Examples 16-20, wherein the curved pacifier guide retainer and the pacifier guide member are constructed of a relatively nonporous material.

The foregoing description has been presented for the purposes of illustration and description. It is not intended to be exhaustive or to limit the disclosure to the precise forms disclosed. Many modifications and variations are possible in light of the above teaching. Further, it should be noted that any or all of the aforementioned alternative implementations may be used in any combination desired to form additional hybrid implementations of the disclosure.

It should be noted that embodiments shown in the figures and described herein are intended to be exemplary and that any variations in the size and the relative proportions of the individual components fall within the scope of this disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A device comprising:
a pacifier guide retainer having an opening; and
a pacifier guide member that is disposable within the opening of the pacifier guide retainer;
wherein the pacifier guide member comprises an elongated guide member comprising a length sufficient to retain the pacifier guide member within the opening of the pacifier guide retainer and allow the pacifier guide member to slide back and forth in the opening.

2. The device of claim 1, wherein the opening of the pacifier guide retainer comprises a first diameter; wherein the pacifier guide member comprises a pacifier stop; wherein the pacifier stop tapers from a second diameter that is the same diameter as the first diameter or is larger than the first diameter to a third diameter that is less than the first diameter.

3. The device of claim 2, wherein the pacifier guide member is retained within the opening when the pacifier stop is rotated such that the second diameter of the pacifier stop contacts the first diameter of the opening.

4. The device of claim 2, wherein the pacifier stop slides back and forth in the opening.

5. The device of claim 1, wherein the opening is an ovoid and the first diameter corresponds to a length of the ovoid opening.

6. The device of claim 1, wherein the pacifier retainer includes a horizontal connector attached to a vertical connector and the vertical connector connects to a headpiece.

7. The device of claim 6, wherein at least one of the horizontal and vertical connector includes an articulation member.

8. A system comprising:
a pacifier guide retainer extending from at least one attachment on a headwear item to a central portion, wherein the central portion includes a guide opening defined by a surrounding sidewall forming a hole therethrough; and
a pacifier guide member comprising:
an attachment portion for attachment to a pacifier at a proximal end of the pacifier guide member; and
an elongated guide member extending outwardly with respect to the attachment portion to a distal end of the pacifier guide member;
wherein the elongated guide member tapers from the distal end towards the attachment portion, such that when the elongated guide member is placed in the guide opening, it partially extends and retracts through the guide opening thereby retaining the pacifier in a position for use by a child.

9. The system of claim 8, wherein the pacifier guide retainer and the pacifier guide member are constructed of a rigid material.

10. The system of claim 8, wherein, the pacifier guide retainer extending from at least one attachment on a headwear item to a central portion comprises the pacifier guide retainer extending from two corresponding attachments on either side of the headwear item to the central portion.

11. The system of claim 8, wherein the pacifier guide retainer comprises at least one downwardly extending portion connected to at least one corresponding horizontal portion, and further comprising at least one articulation joint disposed between the at least one downwardly extending portion and the at least one horizontal portion to allow adjustment therebetween.

12. The system of claim 8, wherein the guide member has a non-circular cross-sectional shape and the hole of the guide opening of the pacifier guide retainer has a corresponding shape, such that the distal end of the guide member may be inserted through the hole of the guide opening when aligned in a specific alignment and then rotated such that it is abuttably prevented from being removed therefrom.

13. The system of claim 8, wherein the headwear comprises a hat, a headband, or a helmet.

14. The system of claim 13, wherein the pacifier guide retainer is attached to loops attached to the headwear.

15. The system of claim 13, wherein the two corresponding attachments comprise two enlarged portions at either end of the pacifier guide retainer that are retained in at least one pocket disposed on the headwear.

16. A pacifier retaining system for a child, comprising:
a rigid pacifier guide retainer that extends from two corresponding attachment structures for attachment to a headwear item to a central guide portion;
a guide opening formed as a hole in the central guide portion, the guide opening defined by a surrounding sidewall; and
a rigid pacifier guide member comprising:
a first end for attachment to a pacifier, and
an elongated guide member extending from the first end to a second end, such that when the elongated guide member is placed in the guide opening, it partially extends and retracts through the guide opening.

17. The system of claim 16, wherein the elongated guide member tapers from the second end towards the first end, such that when the elongated guide member is placed in the guide opening in the central guide member, it partially extends and retracts through the guide opening and is abuttably prevented from being removed therefrom.

18. The system of claim 17, wherein the elongated guide member has a non-circular cross-sectional shape and the hole of the guide opening has a corresponding shape, such that the distal end of the guide member may be inserted through hole of the guide opening when aligned in a specific alignment and then rotated such that it is abuttably prevented from being removed therefrom.

19. The system of claim 16, wherein the two corresponding structures for attachment to a headwear item comprise two enlarged portions at either end of the pacifier guide retainer that are retained in at least one pocket disposed on the headwear.

20. The system of claim 16, wherein the pacifier guide retainer comprises at least one downwardly extending portion connected to at least one corresponding horizontal portion, and further comprising at least one articulation joint disposed between the at least one downwardly extending portion and the at least one horizontal portion to allow adjustment therebetween.

21. The system of claim 16, wherein the curved pacifier guide retainer and the pacifier guide member are constructed of a relatively nonporous material.
